(19) United States
(12) Patent Application Publication
(10) Pub. No.: US 2026/0217093 A1
(43) Pub. Date: Jul. 30, 2026

(54) Two-Part Entry Door System for Recreational Vehicles and Campers

(71) Applicant: Stefan Leopold Zawistowski, Briarwood, NY (US)

(72) Inventor: Stefan Leopold Zawistowski, Briarwood, NY (US)

(21) Appl. No.: 19/575,411

(22) Filed: Mar. 23, 2026

Related U.S. Application Data
(60) Provisional application No. 63/854,032, filed on Jul. 30, 2025.

(51) Int. Cl. B60J 5/04; B60R 3/02; E05F 15/60

(52) U.S. Cl. CPC B60J 5/0468; B60J 5/0401; B60J 5/0412; B60R 3/02; E05F 15/60; E05Y 2900/512

(57) ABSTRACT

A two-part entry door system for a vehicle includes an upper door section and a lower door section pivotally mounted to a door frame. The upper door section is configured to move to an open position extending upwardly relative to the door frame, and the lower door section is configured to move to an open position extending downwardly relative to the door frame. The lower door section includes an access structure configured to deploy upon opening, the access structure comprising at least one of a plurality of steps or a ramp surface configured to support wheeled mobility devices, the access structure being configured to deploy in response to movement of the lower door section. In some embodiments, the system includes an actuation mechanism and at least one sensor configured to control the movement of the door sections.

### CROSS-REFERENCE TO RELATED APPLICATIONS

This application is a continuation-in-part of U.S. Non-Provisional patent application Ser. No. 19/575,411, filed Mar. 23, 2026, which claims the benefit of U.S. Provisional Application No. 63/854,032, filed Jul. 30, 2025. The entire contents of each of the foregoing applications are incorporated herein by reference.

### STATEMENT REGARDING FEDERALLY SPONSORED RESEARCH

Not applicable.

### FIELD OF THE INVENTION

The present invention relates to entry door systems for vehicles, and more particularly to a two-part entry door system for recreational vehicles and campers that improves accessibility, safety, and space utilization.

### BACKGROUND OF THE INVENTION

Conventional entry door systems for recreational vehicles and campers typically require a dedicated stairwell space within the vehicle.

Such stairwell configurations occupy valuable interior space and may pose safety risks due to stepping into the recessed area.

Existing systems may also include deployable external steps that can interfere with curbs or terrain and are not integrated into the door structure.

These configurations limit design flexibility and do not provide adaptable access modes for different users, including individuals requiring wheelchair access.

There remains a need for an improved entry system that enhances safety, accessibility, and efficient use of interior space.

### SUMMARY OF THE INVENTION

The present invention provides a two-part entry door system comprising an upper door section and a lower door section configured to move relative to a door frame.

The lower door section pivots downward to provide access, eliminating the need for a recessed interior stairwell.

The access structure may comprise one or more step elements or a ramp surface.

In certain embodiments, deployment of the access structure is caused by gravitational forces, biasing elements, or actuation systems.

In certain embodiments, the lower door section includes an integrated access structure that deploys automatically upon opening.

In some embodiments, movement of one of the upper or lower door sections permits, induces, or accommodates movement of the other.

In certain embodiments, the lower door section is selectively configurable between a stepped configuration and a ramp configuration.

In some embodiments, a platform element is deployable from the lower door section to extend the ramp surface.

The system may include an actuation system comprising mechanical, hydraulic, or electromechanical components.

In certain embodiments, sensors are provided to detect obstructions and control operation.

The system may be configured to operate in multiple modes, including step, ramp, and partial-opening modes.

### BRIEF DESCRIPTION OF THE DRAWINGS

FIG. 1 is a front view of the door assembly installed in a vehicle in a closed position.

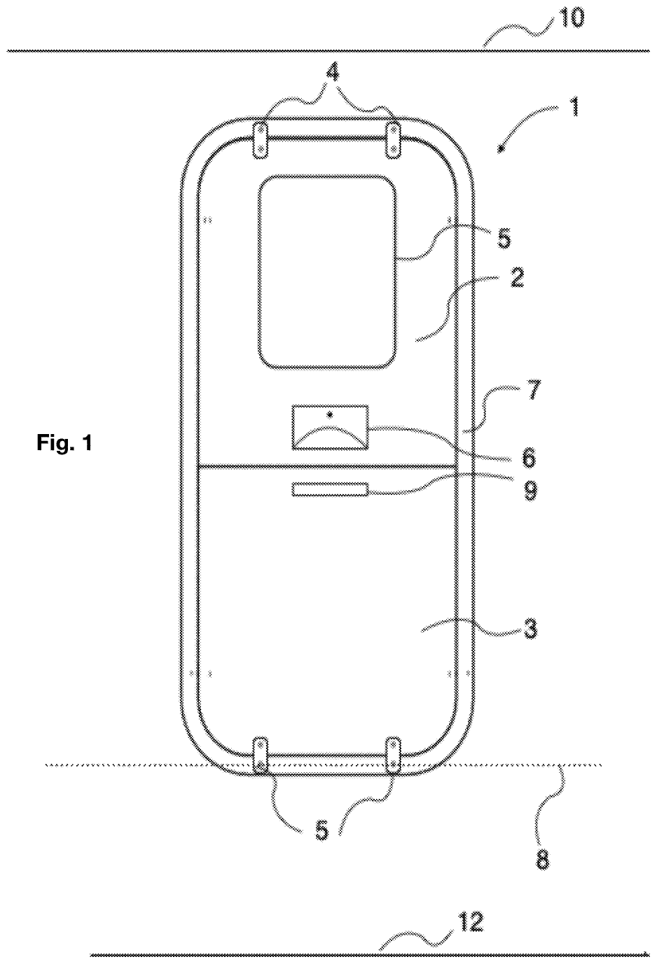

FIG. 2 shows the lower door section opened with steps.

FIG. 3 is a side view of the system in an open position.

FIG. 4 shows the lower door section forming a ramp.

FIG. 5 is a schematic view of the system operation, including a side view of the access structure (ramp).

FIG. 6 shows an example of a variant ramp structure with a wheelchair platform in a closed position.

FIG. 7 is a view of an example of the variant ramp in an intermediate opening position.

FIG. 8 is a view of an example variant ramp in an open position, configured to permit wheelchair access to and from the vehicle.

FIG. 9 shows an example of the variant ramp in its fully deployed position for wheelchair access.

FIG. 10 shows a top view of the lower door section forming a ramp (a) and an example of a variant ramp (b) in an open position.

FIG. 11 shows a perspective view of the lower part in the closed position, with the electronic sensor (19) located to prevent collisions with curbs or other obstacles.

### DETAILED DESCRIPTION OF THE INVENTION

The invention provides a two-part entry door system for a vehicle such as a recreational vehicle or camper.

The system includes a door frame mounted within a vehicle wall.

The lower portion of the door frame is positioned substantially at the vehicle floor level.

In certain embodiments, the door system defines a two-part access architecture integrated within a vehicle wall, and the lower door section includes an access surface retained within the lower door section when closed and configured to deploy upon opening to provide ingress to the vehicle interior.

The upper and lower door sections are arranged such that, in an open configuration, the upper door section extends upwardly and the lower door section extends downwardly, defining an access opening therebetween.

An upper door section is pivotally mounted to the door frame. It is configured to rotate about a hinge axis to an open position extending upwardly relative to the door frame.

A lower door section is pivotally mounted at a lower portion of the door frame. It is configured to rotate about a hinge axis to an open position extending downwardly relative to the door frame.

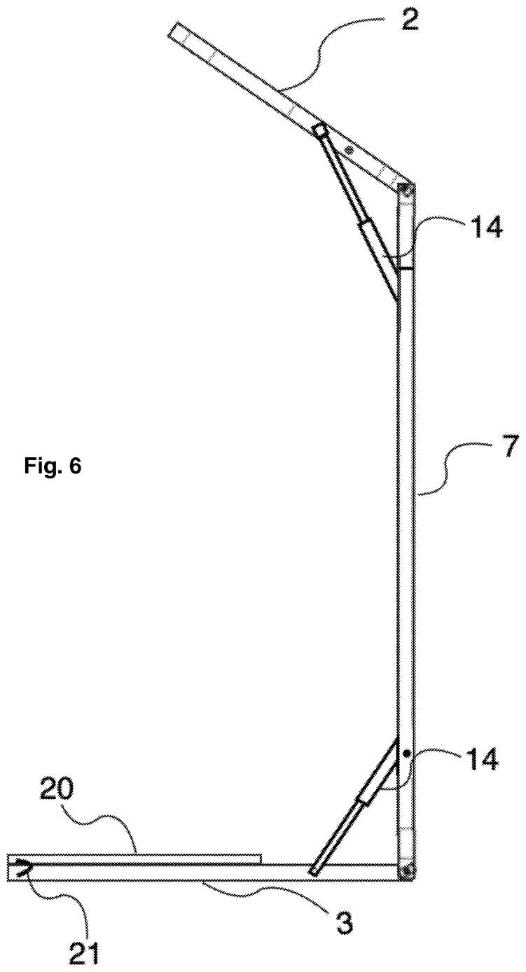

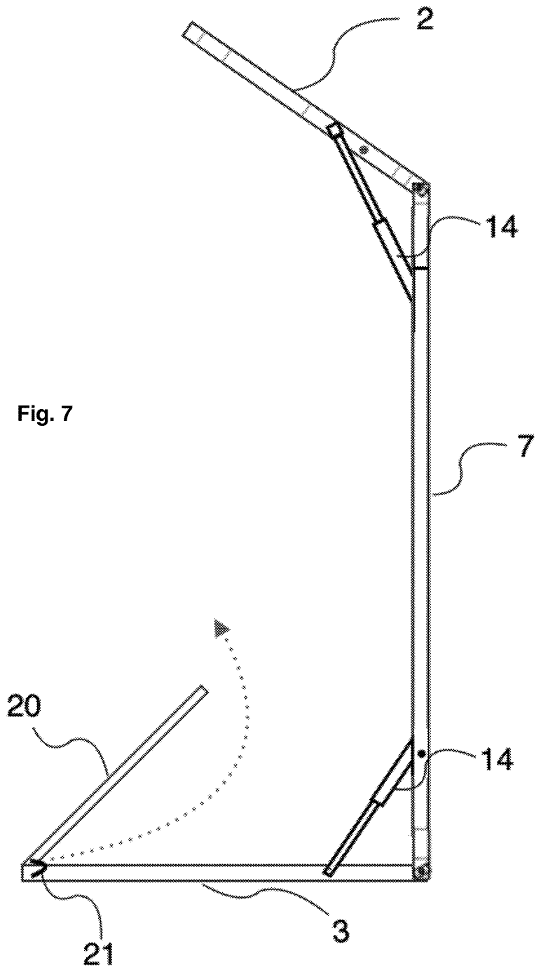

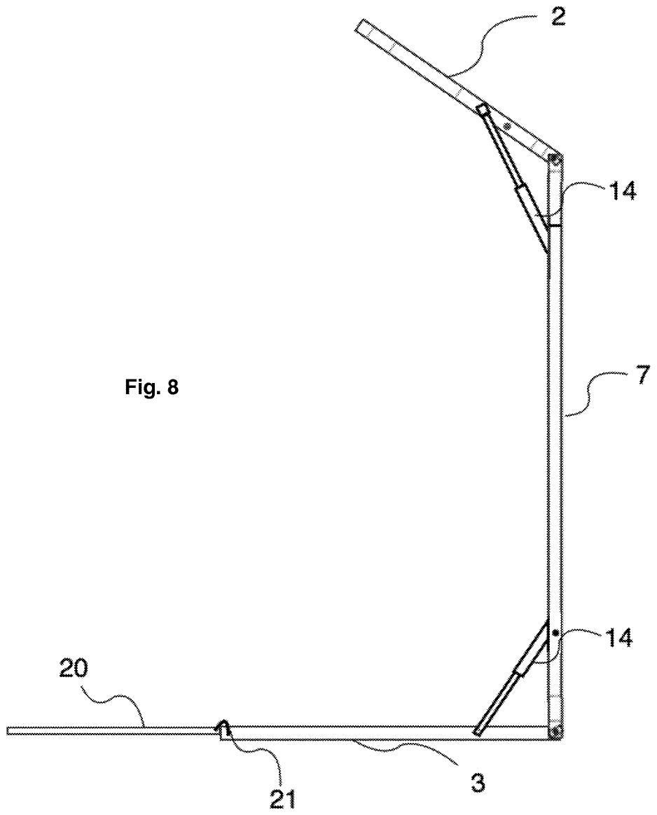

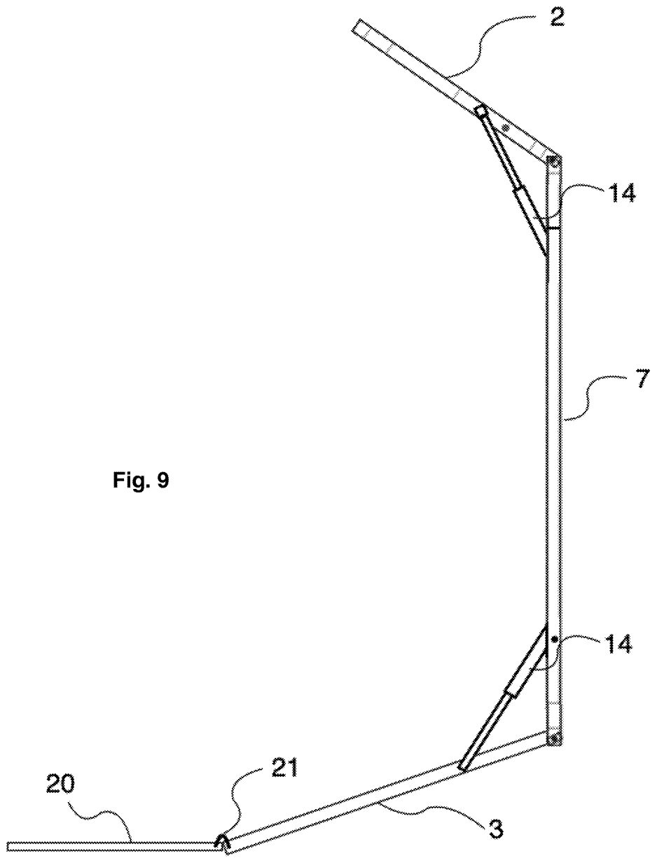

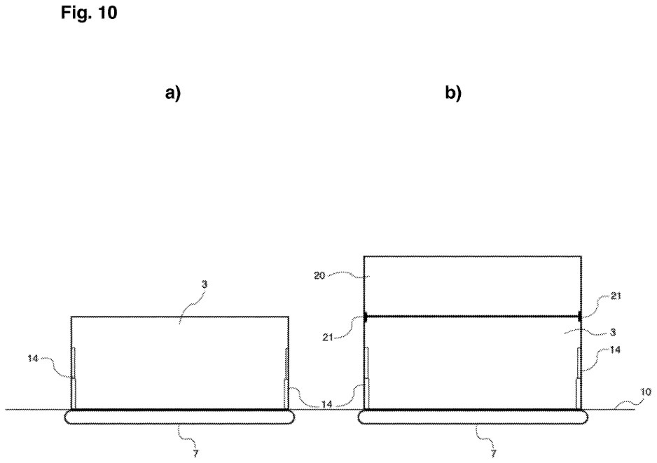

In certain embodiments, the lower door section includes an integrated wheelchair access structure (20 in FIGS. 6, 7, 8, 9, and 10b) retained within the door when the door is in its closed position.

The access structure is configured to deploy in response to the movement of the lower door section.

In some embodiments, deployment occurs due to gravitational forces acting on internal elements.

In alternative embodiments, deployment is assisted by springs, biasing members, lugs (21 in FIGS. 6, 7, 8, 9), and/or mechanical linkages.

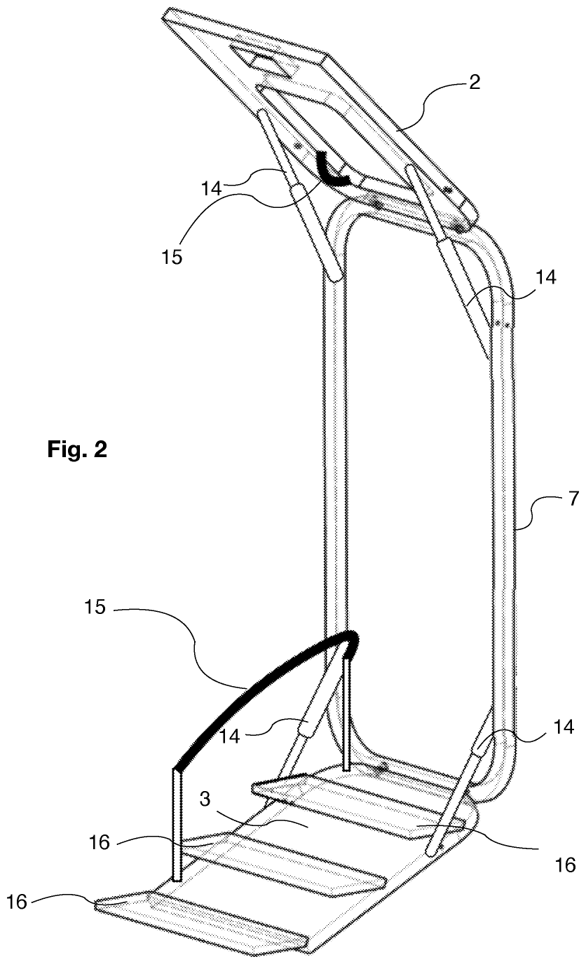

In certain embodiments, the access structure comprises a plurality of step elements configured to form a staircase (FIG. 2).

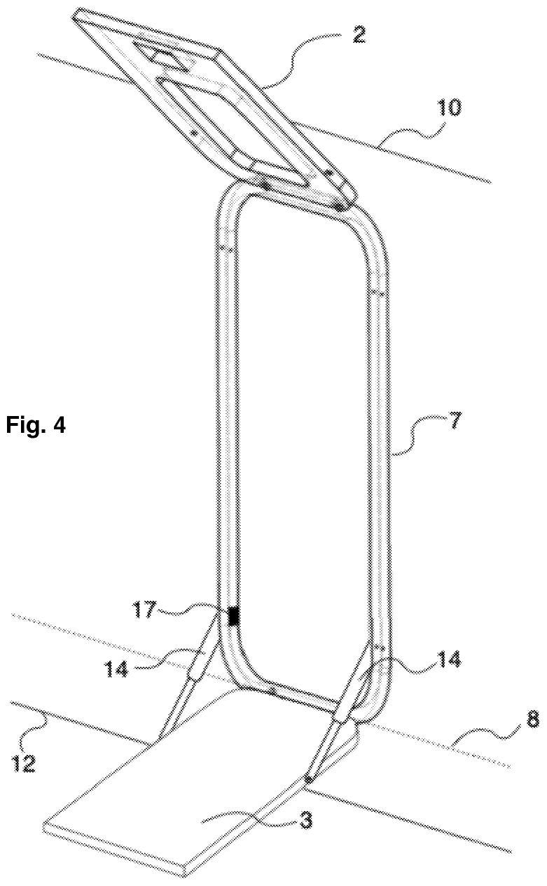

In other embodiments, the lower door section forms a continuous ramp surface (FIG. 4).

The ramp surface may include reinforcement and anti-slip features.

In certain embodiments, the ramp configuration enables access by wheeled mobility devices, including wheelchairs, and may be suitable for applications requiring wheelchair-accessible vehicle configurations.

In certain embodiments, a platform element (20 in FIGS. 6, 7, 8, 9, and 10b) is provided, deployable from the lower door section.

The platform element may extend outward and maintain a substantially horizontal orientation during deployment.

The platform element may be actuated manually, mechanically, or electrically.

In certain embodiments, movement of the upper and lower door sections is coordinated.

Movement of one door section may permit, induce, or accommodate movement of the other.

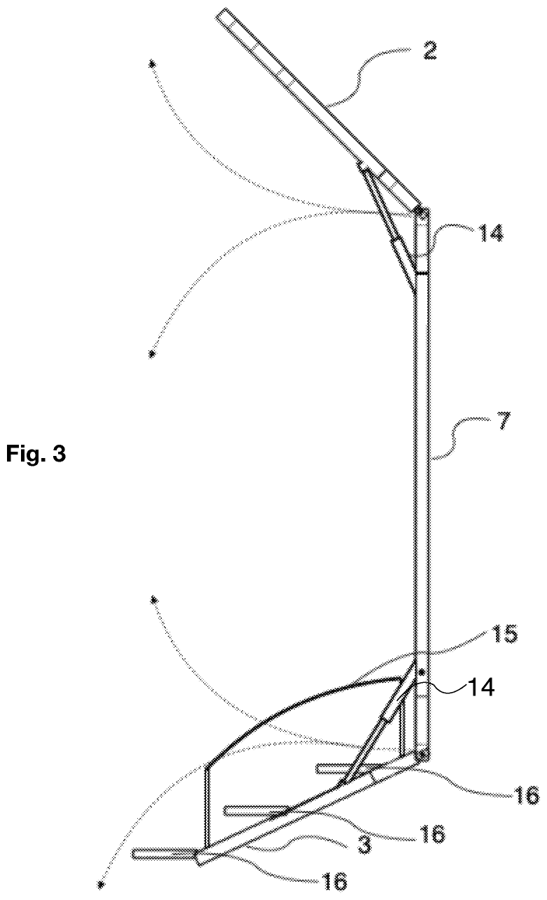

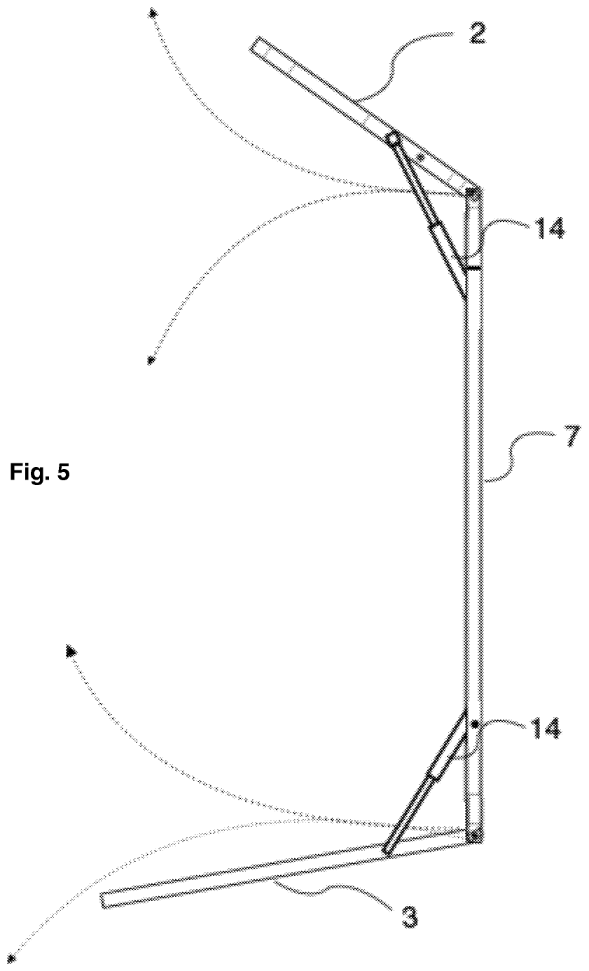

The system may include gas struts (14 in FIGS. 2, 3, 4, 5, 6, 7, 8, 9, and 10), hydraulic supports, or electromechanical actuators.

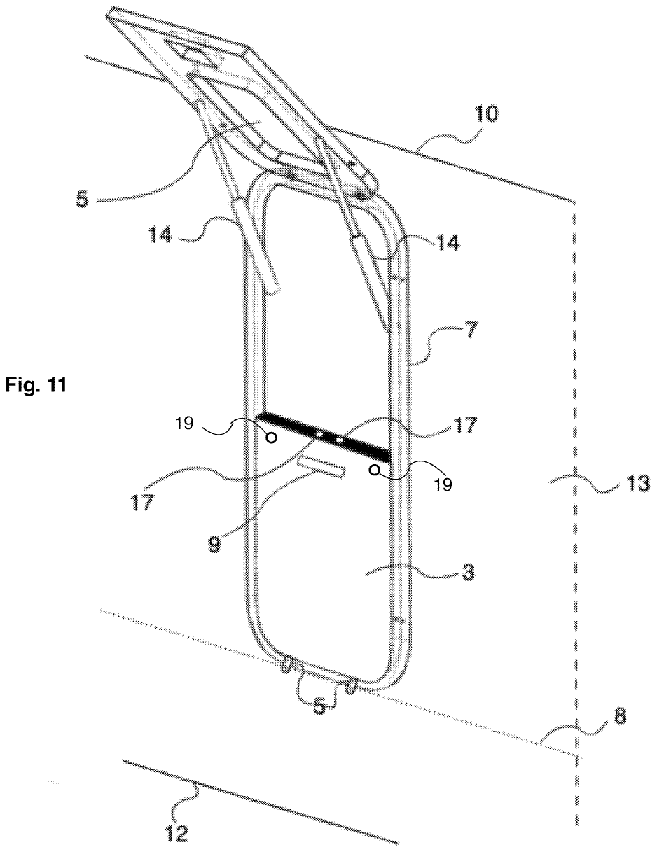

In certain embodiments, sensors (19 in FIG. 11) are provided to detect obstruction or load conditions.

The system may automatically stop or adjust movement in response to sensor input.

The system may be configured for multiple operational modes.

In a step mode, the lower door section deploys steps.

In a ramp mode, the lower door section forms a continuous inclined surface.

In partial-opening mode, only the upper door section opens.

The system may include sealing elements and structural reinforcements.

The configuration provides access and enables alternative interior layouts by eliminating the need for a recessed stairwell.

1. A door system for a vehicle comprising a door frame mounted to a vehicle body; an upper door section hingedly coupled to an upper portion of the door frame and configured to pivot upward relative to the door frame between a closed position and an open position; a lower door section hingedly coupled to a lower portion of the door frame and configured to pivot downward relative to the door frame between a closed position and an open position;
wherein the upper door section and the lower door section are configured to align to form a substantially continuous closure when in the closed position, and the lower door section is configured to provide access to the interior floor of the vehicle when in the open position.

2. The door system of claim 1, wherein the lower door section includes one or more panels configured to deploy when the lower door section opens to form steps.

3. The door system of claim 2, wherein the panels are configured to deploy under gravitational force when the lower door section pivots downward.

4. The door system of claim 2, wherein the panels are deployable via mechanical or electromechanical actuation.

5. The door system of claim 1, wherein at least one of the upper door section and the lower door section is supported by one or more gas struts or hydraulic supports.

6. The door system of claim 1, wherein the upper door section is operable independently of the lower door section.

7. The door system of claim 6, wherein the upper door section is configured to open while the lower door section remains closed to provide ventilation while maintaining a barrier.

8. The door system of claim 1, wherein the lower door section is configured to function as a ramp when in the open position.

9. The door system of claim 1, wherein the door sections are operable manually or via electromechanical actuators.

10. The door system of claim 1, wherein the upper and lower door sections are configured to overlap or abut when closed.

11. A door system for a vehicle comprising:
an upper door section;
a lower door section pivotally mounted to a door frame of the vehicle;
wherein the lower door section is configurable between:
(a) a stepped configuration; and
(b) a ramp configuration.

12. The door system of claim 11, wherein the lower door section includes an access structure configured to deploy upon opening.

13. The door system of claim 12, wherein the access structure is deployed by at least one of gravitational force or a biasing mechanism.

14. The door system of claim 11, wherein movement of one of the upper door section and the lower door section permits, induces, or accommodates movement of the other.

15. The door system of claim 11, further comprising a platform element deployable from the lower door section.

16. The door system of claim 15, wherein the platform element maintains a substantially horizontal orientation during deployment.

17. The door system of claim 15, wherein the platform element is deployable by manual, mechanical, or electromechanical actuation.

18. The door system of claim 11, further comprising an actuation system configured to control the movement of the door sections.

19. The door system of claim 11, further comprising at least one sensor configured to detect obstruction.

20. The door system of claim 11, wherein the system is configurable to operate in a plurality of modes, including a step mode and a ramp mode.

21. The door system of claim 1, wherein at least one of the upper door section and the lower door section is pivotally mounted to the door frame.

22. The door system of claim 1, wherein the upper and lower door sections are mounted for rotational movement about respective hinge axes.

23. The door system of claim 11, wherein the access structure is integrated within the lower door section and deploys from a stored position within the lower door section to an access position upon opening.
